(19) United States
(12) Patent Application Publication
(10) Pub. No.: US 2022/0092714 A1
(43) Pub. Date: Mar. 24, 2022

(54) MOBILE MODULAR FOLDING BIOMETRIC APPARATUS

(71) Applicant: INCADENCE STRATEGIC SOLUTIONS CORPORATION, Manassas, VA (US)

(72) Inventors: Anthony S. Iasso, Middleburg, VA (US); Daniel lasso, Towaco, NJ (US); John P. McIntyre, Stephens City, VA (US); Ashley Thompson, Warrenton, VA (US)

(73) Assignee: INCADENCE STRATEGIC SOLUTIONS CORPORATION, Manassas, VA (US)

(21) Appl. No.: 17/421,484

(22) PCT Filed: Nov. 19, 2019
(86) PCT No.: PCT/US19/62097

§ 371 Date: Jul. 8, 2021

Related U.S. Application Data
(60) Provisional application No. 62/791,314, filed on Jan. 11, 2019.

(51) Int. Cl. G06Q 50/26; H01R 35/02; G06F 1/16

(52) U.S. Cl. CPC G06Q 50/26; G06V 40/13; G06F 1/1633; H01R 35/02

(57) ABSTRACT

A mobile modular biometric apparatus includes a first case to support a mobile terminal and a second case to support at least one biometric sensor. A coupler rotatably couples the first case to the second case, and a plurality of conductive lines carry signals between the mobile terminal and the at least one biometric sensor. The signals include biometric information from the biometric sensor. The coupler controls the first case and the second case to rotate between open and closed positions. The first case overlaps the second case in the closed position and has a different orientation relative to the second case in the open position.

### FIELD

One or more embodiments herein relate to biometric devices and applications.

### BACKGROUND

The security threats that exist today are perhaps more serious than ever before. These threats extend not only to individuals but also to organizations, corporations, and whole nations. The efforts in place to preempt those threats have not always proven effective, often because of delays or inadequate intelligence. As a result, efforts are continually being made to develop efficient tools to help security personnel in carrying out their jobs.

One tool that is gaining widespread appeal uses biometric data to identify terrorists, criminals, or other persons of interest. However, the processes that presently exist for collecting and processing biometric data are considered out of date. For example, biometric collection equipment and computer systems are often located at central facilities. This makes identity verification in the field impossible. Attempts have been made to make portable equipment, so that security officers and soldiers can use them on site. However, this equipment is expensive, cumbersome, and prone to breaking.

### SUMMARY OF THE INVENTION

One or more embodiments described herein provide a mobile modular biometric apparatus that may be used to collect one or more forms of biometric information from subjects of interest.

In accordance with these or other embodiments, the mobile modular biometric apparatus may be integrated to include one or multiple biometric sensors. When multiple sensors are included, the mobile modular biometric apparatus may be used, for example, by military, law enforcement, and intelligence communities to carry out operations.

In accordance with these or other embodiments, the mobile modular biometric apparatus may acquire biometric information from one or multiple sensors in a form compatible with private or government standards, including but not limited to those of the Federal Bureau of Investigation (FBI), military, Homeland Security, Border Patrol, Department of Defense, and police departments, to name a few.

The apparatus may include a mobile terminal that exchanges information wirelessly with remote servers for authentication and identity verification. The mobile modular biometric apparatus may therefore serve as a useful tool to field personnel in preempting dangerous threats or otherwise restricting access to protected areas and/or equipment.

In accordance with these or other embodiments, the mobile terminal may be a commercially available terminal, such as, but not limited smart phones, tablets, and handheld computers.

In accordance with these or other embodiments, the mobile modular biometric apparatus may operate based on power from the mobile terminal, a battery pack, or both.

In accordance with these or other embodiments, the biometric sensor(s) may be updated simultaneously and automatically when updating application software running on the mobile terminal used to acquire, process, and communicate biometric information.

In accordance with these or other embodiments, the mobile modular biometric apparatus may include supporting features made from rigid materials that make the apparatus rugged and thus suitable for use in the field.

These or other embodiments described herein correspond to a mobile modular biometric apparatus including a first case to support a mobile terminal, a second case to support a first biometric sensor, a coupler to rotatably couple the first case to the second case, and a plurality of conductive lines to carry signals between the mobile terminal and the first biometric sensor. The signals include biometric information from the first biometric sensor. The coupler controls the first case and the second case to rotate between an open position and a closed position. The first case overlaps the second case in the closed position and has a different orientation relative to the second case in the open position. The different orientation may be a side-by-side orientation or another orientation where the first case is at a predetermined angle relative to the second case that makes biometric data easily acquirable from a subject.

The first case may support a display screen of the mobile terminal and the second case may support a sensing surface of the first biometric sensor to face a same direction or in different (e.g., opposing) directions in the open position. The coupler may include at least one hinge to rotate the first case relative to the second case. The apparatus may include a stop to set the first case at a predetermined angle relative to the second case in the open position. The apparatus may include a rotation controller to move the first and second cases between open and closed positions.

The first case may include a removable coupling for the mobile terminal, and the second case may include a removable coupling for the first biometric sensor. The second case may support a second biometric sensor and may have opposing sides to support the first biometric sensor and the second biometric sensor, respectively. The conductive lines may carry power to the first biometric sensor and the second biometric sensor. A hub or other type of routing circuit may control signal transmission between the conductive lines and the first and second biometric sensors.

In accordance with these or other embodiments, the first case may support a battery pack at a position adjacent to the mobile terminal. The first case may hold the battery pack at a distance from the mobile terminal sufficient to allow inductive charging to take place between coils in the battery pack and mobile terminal. The first case may include a recess corresponding to a profile of a connector of the conductive lines, and a surface of the first case may at least partially surround the connector when the connector is in the recess. The recess may expose charging ports of the mobile terminal and battery pack, and the surface of the first case may at least partially surround a portion of the connector which includes connector plugs to be inserted into respective ones of the charging ports. Additionally or alternatively, the second case may be configured to support a battery pack at a position adjacent to the first biometric sensor. The second case may include one or more further conductive lines to connect the battery pack and the first biometric sensor and carry power from the battery pack to the first biometric sensor. The second case alternatively may hold the battery pack at a distance from the first biometric sensor sufficient to allow inductive charging to take place between coils in the battery pack and mobile terminal.

The signal lines may carry power from the battery pack or mobile terminal to the first biometric sensor. The apparatus may include a retention strap to maintain the first and second cases in the closed position, for example, during travel or use. The apparatus may include an attachment on the first case and/or the second case to receive a hand strap. The mobile terminal may be a smart phone, a tablet, and handheld computer, or a personal digital assistant. The biometric sensors may be any one of a fingerprint reader, palm reader, palm vein reader, an iris scanner, retina scanner, a microphone for voice recognition, or a camera for recognition of a body part or feature.

### BRIEF DESCRIPTION OF THE DRAWINGS

FIG. 1 shows an embodiment of mobile modular biometric apparatus in an open position.

FIG. 2 shows an example of a side view of the mobile modular biometric apparatus.

FIG. 3 shows an example of a top view of the mobile modular biometric apparatus.

FIG. 4 shows an embodiment of a cable for the mobile modular biometric apparatus.

FIG. 5A shows an example of a battery in the first case, and FIG. 5B shows an assembled view of the first case including the battery.

FIGS. 6A-6D show an example for assembling the battery and mobile terminal.

FIG. 7A shows an embodiment of the mobile modular biometric apparatus in a closed position, and FIGS. 7B and 7C show an example of an internal layout of a dual-iris scanner.

FIG. 8 shows an embodiment including a stop for setting a rotation angle.

FIGS. 9A-9C show an embodiment of a cable for the mobile modular biometric apparatus.

FIG. 10 shows an example of how the mobile modular biometric apparatus is charged.

FIG. 11 shows an embodiment for transmitting biometric and other signals.

FIG. 12 shows an embodiment for transferring power through inductive coupling.

FIG. 13 shows an embodiment including a retention strap.

FIGS. 14A-14C show different views of an embodiment including a hand strap.

FIG. 15 shows an embodiment of a modular mobile modular biometric apparatus.

FIG. 16 shows an example of using the modular mobile modular biometric apparatus.

FIG. 17 shows an example of a control screen of an application program for collecting, processing, transmitting, and receiving biometric and other information.

### DETAILED DESCRIPTION

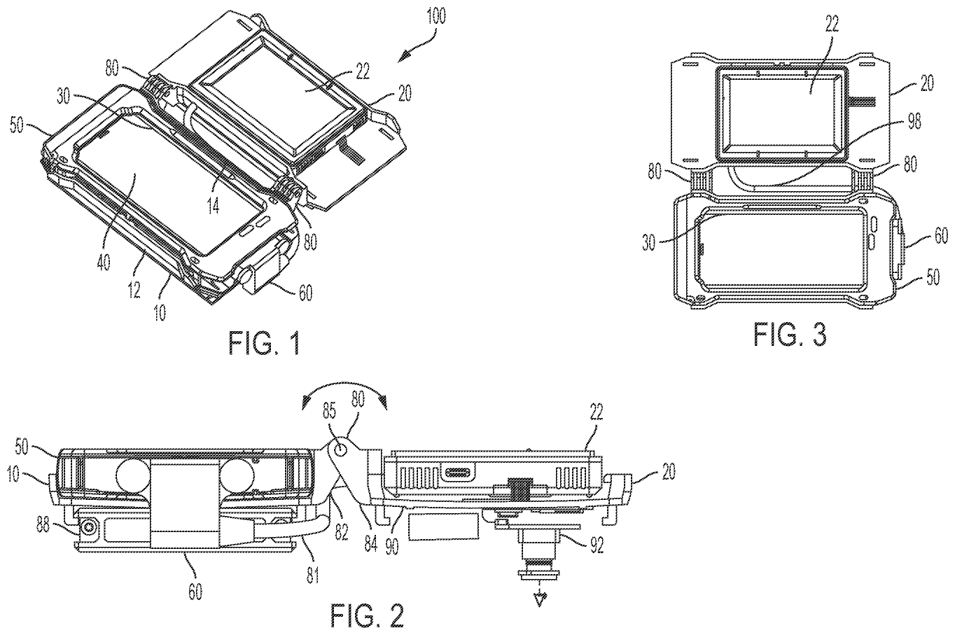

FIG. 1 shows an embodiment of a mobile modular biometric apparatus 100 for collecting and processing biometric information for various applications. The mobile modular biometric apparatus 100 may serve as a valuable tool for use by police, Homeland Security personnel, Border Patrol officers, intelligence agents, Social Services representatives, Department of Defense employees, and military professionals in identifying subjects in real-time. The mobile modular biometric apparatus 100 may also be used for controlling access to restricted areas, authenticating parties in financial transactions, verifying identity for purposes of medical treatment, transportation, voting, maintenance, package delivery, network or computer access, or performing other applications where security is of interest.

Referring to FIG. 1, the mobile modular biometric apparatus 100 includes a first case 10 rotatably coupled to a second case 20. This coupling allows the apparatus to rotate between open and closed positions. For example, the apparatus 100 may be rotated to a closed position for carrying by a user, storage, or otherwise when not in use. The apparatus may be rotated to at least one open position (e.g., as shown in FIG. 1) when biometric information is to be acquired from a person of interest, an application is to be used, and/or for various other uses.

The first case 10 supports or is otherwise coupled to a mobile terminal 30, which includes a display screen 40 and circuits for storing operating system soft are, applications including a biometric application, and data including information received from one or more biometric sensors as described below. The mobile terminal 30 may also include processing circuits and a communication interface for carrying out biometric information exchange and identification.

The communication interface may allow for wireless network access to one or more databases storing biometric information of persons of interest. The biometric information collected by the mobile modular biometric apparatus 100 may be compared with the biometric information (e.g., by internal circuits of the mobile terminal 30, a remote server, or both) stored in the databases for identification purposes. The databases may be maintained by a governmental (e.g. FBI, military, homeland security, etc.) or private entity. In one embodiment, the mobile terminal 30 may include or be coupled to a memory or other device storing biometric information for comparison to the collected biometric information. In this latter embodiment, the mobile modular biometric apparatus 100 may be considered to be a stand-alone device.

The mobile terminal 30 may be any type of a commercially available data terminal. Examples include but are not limited to a smart phone, tablet, handheld computer, personal digital assistant, or another type of information or data terminal. In one embodiment, the mobile terminal 30 may be a specially dedicated device for collecting and processing biometric information for subject identification or authentication.

In order to provide enhanced protection, the first case 10 may fully or partially surround edges of the mobile terminal 30. In the example shown in FIG. 1, the first case includes side portions 12 and 14 which securely hold a pair of opposing side surfaces of the mobile terminal 30 in place within the case, for example, through a friction or snap fit. Additionally, or alternatively, the first case 10 may include features that allow the mobile terminal 30 (or frame) to snap, screw, hook, connect to, mate with, or fasten to features on the first case 10. One or more portions of the mobile terminal 30 may be exposed, for example, to allow for access to various ports, control buttons, inputs, speakers, and/or other features.

In one embodiment, the mobile terminal 30 may be held within a frame 50, and the frame 50 may be inserted into the first case 10 and held in place, for example, by side portions 12 and 14. The frame 50 may provide enhanced protection to the mobile terminal 30 (e.g., against vibration, shock, impact, etc.) when used in the field or other real-world conditions. The frame 50 may include one or more openings, open edges, or recesses to allow for access to or to provide clearance for controls (e.g. volume, on/off buttons, etc.), a camera, sensors, a charging/accessory port, or other features of the mobile terminal 30. In FIG. 1, a removable connector 60 is shown as being inserted into a charging/accessory port of the mobile terminal 30.

The second case 20 includes or otherwise supports at least one biometric sensor. The at least one biometric sensor is secured on or within the second case 20, for example, through a friction fit. Additionally, or alternatively, the second case 20 may include features that allow the first biometric sensor to snap, screw, hook, connect to, mate with, or fasten to features on the second case 20. The size of the second case 20 may be the same as or different from the size of the first case 10.

In FIG. 1, the second case 20 is shown to include a first biometric sensor 22 in the form of a fingerprint reader. The fingerprint reader may be a single-finger reader or a four-slap fingerprint reader for reading the prints of four fingers at one time. An example of a four-slap fingerprint reader is a Five-0 or certified FAP 50 fingerprint sensor made by Integrated Biometrics, which conforms to the standards set forth in the FBI Appendix F fingerprint specification. In such a case, the scanning or reading surface 24 of first biometric sensor 22 is shown in opposing relation to the display surface of the mobile terminal 30. In another embodiment, the first biometric sensor 22 may be another type of biometric sensor, e.g., a palm reader, a palm vein reader, an iris scanner, a camera for recognition of a body part or body feature (e.g., face, body defects or peculiarities, tattoos, etc.), retina scanner, a microphone for voice recognition, or a sensor for collecting another type of biometric information.

The second case 20 may surround or cover all edges of the first biometric sensor 22 or fewer than all edges (e.g., two or three edges). In one embodiment, a protective transparent cover may stretch across the second case 20 in order to seal the first biometric sensor 22 from moisture, dust, corrosion, or other environmental influences. In one embodiment, the size of the second case 20 may correspond to a size or dimension of at least the display 40 of the mobile terminal 30, so that the second case 20 may protect the display screen 40 when the apparatus 100 is in a closed position. In one case, the size of the second case 20 may equal the size or one or more dimensions of the first case 10. The mobile terminal 30 and first biometric sensor 22 may be held within their respective cases so that the sensing surface of the biometric sensor 22 and display screen 40 of the mobile terminal 30 are separated by a predetermined clearance (e.g., non-contact) distance in a closed position.

The first case 10, the second case 20, and/or the frame 50 may be made of the same material or different materials. For example, at least the first case 10 and the second case 20 may be made of metal, polycarbonate, or composite material sufficiently rigid to withstand shock, vibration, or external impact that may damage the first biometric sensor 22. When constructed in this manner, the apparatus 100 may be considered to be ruggedized and, thus, suitable for use by professionals in the field. Ire one embodiment, a protective transparent cover may be placed across the first case 10 to seal the mobile terminal 30 from moisture, dust, corrosion, or other environmental influences.

The rotatable coupling between the first case 10 and the second case 20 may be accomplished in various ways. Examples includes a disc coupling, fluid coupling, beam coupling, jaw coupling, Hooke coupling, magnetic joint coupling, Schmidt coupling, sleeve coupling, or other types of couplers or rotatable connections.

FIG. 2 shows an example of a rotatable coupling (or coupler) 80 that may be used to movably join the first case 10 and the second case 20 of FIG. 1. The rotatable coupling 80 includes one or more arms 82 extending from the first case 10 at a predetermined angle and one or more arms 84 extending from the second case 20 at the same or different predetermined angle. The angles of the arms 82 and 84 may be designed to allow the first case 10 and the second case 20 to lie flat or at another orientation relative to one another. The arms may be coupled by one or more pins 85. The rotatable coupling may be, for example, one or more hinges that include arms 82 and 84. When the first case 10 and second case 20 are pulled part or pushed together by a user, the arms 82 and 84 articulate (see arrow) relative to one another into open and closed positions. In one embodiment, a stop may be provided on or adjacent or coupled to one or more of the arms 82 and 84 to set the orientation (or range of rotation) of the first case 10 and the second case 20 in the open position. The angular range of rotation may be, for example, any angle between 0° and 180° inclusive.

The first biometric sensor 22 may be the only biometric sensor in apparatus 100. In another embodiment, as shown in FIG. 2, the second case 20 may include at least a second biometric sensor 92 supported, for example, on an opposing surface 90 relative to the first biometric sensor 22. The second biometric sensor 92 may be secured to surface 90, for example, by a clip, screw, or other type of mounting or attachment or may be integrally formed with a housing of the second case 20. The second biometric sensor 92 may be an iris scanner. One example is a dual iris scanner, e.g., an IriTech iris scanner (e.g., iriShield BO-2121) with dual cameras. An embodiment with two biometric sensors may be suitable for many military and law enforcement applications, where, for example, both fingerprint and iris scans are required for identification.

The second biometric sensor 92 may be a different kind of biometric sensor in another embodiment, e.g., a palm reader, a palm vein reader, a fingerprint scanner, a camera for recognition of a body part or body feature (e.g., face, body defects or peculiarities, tattoos, etc.), retina scanner, a microphone for voice recognition, or a sensor for collecting another type of biometric information.

FIG. 3 shows an example of a top view of the mobile modular biometric apparatus 100 in the open position. In this view, a cable 98 is shown to electrically connect the mobile terminal 30 and the first biometric sensor 22. A first end of the cable 98 is coupled to connector 60, and a second end of the cable 98 may extend through the second case 20 to connect to the first biometric sensor 22. If the second biometric sensor 92 is included, the cable 98 may electrically connect mobile terminal 30 to both biometric sensors 22 and 92. The cable 98 may at least partially extend in a space between the first case 10 and the second case 20 when the mobile modular biometric apparatus 100 is in an open position. The cable 98 is shown to have a substantially S-shape configuration, but in another embodiment the cable 98 may have a different shape, es., a linear shape extending straight across the space between the hinges 80.

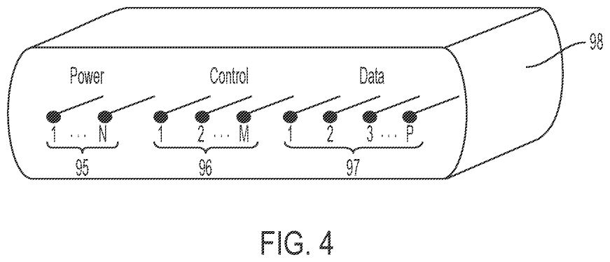

FIG. 4 shows an embodiment of an internal configuration of the cable 98. As shown in FIG. 4, cable 98 includes signal lines for transmitting various signals between the biometric sensors 22/92 and the mobile terminal 30. These signals may include power signals, control signals, and/or data signals. The connector 60, which is connected to one end of the cable 98, may include signal lines, pins, or contacts corresponding to each type of signal (generally referred to as lines below).

As shown in FIG. 4, cable 98 has N power lines 95, M control lines 96, and P data lines 97. The numbers of N, M, and P may be the same or different. The power lines 95 carry power from the mobile terminal 30 to power the biometric sensor(s) 22/92. This power may be derived from the battery of the mobile terminal 20, battery 88 (e.g., see FIG. 2), and/or power from a charger, if the mobile terminal is charging. By powering the biometric sensor(s) 22/92 based on power from the mobile terminal 30 or battery 88, the biometric sensor(s) 22/92 are not required to have their own batteries or power sources. Thus, the biometric sensor(s) do not have to be charged separately. This increases efficiency and reduces costs. In one embodiment, biometric sensor(s) 22/92 are powered only based on power from the mobile terminal 30 or battery 88 passing through power lines of cable 98. In one embodiment (discussed in greater detail below), charging of the battery is performed by inductive coupling.

The control lines 96 carry control signals between the mobile terminal 30 and the biometric sensor(s) 22/92. Some of the control signals may be generated by a biometric application running on the mobile terminal 30, For example, when such a biometric application is selected (or otherwise activated) by a user, the application may generate control signals to activate the biometric sensor(s) and then place the sensor(s) in a mode for receiving or collecting biometric information. The control signals may then instruct the sensor(s) to send the captured or collected biometric information to the mobile terminal 30 for processing, storage, transmission to a remote server, matching, and/or to perform another function.

The data lines 97 carry the biometric information captured or collected by the biometric sensor(s) 22/92 to the mobile terminal 30. The biometric information may be carried on the data lines 97 in various ways, e.g., a sampled digital form corresponding to a predetermined template. The template may be, for example, a fingerprint template, iris template, face template, etc. In one embodiment, the mobile terminal may packetize the biometric information received from the data lines 97 for encrypted secure transmission to a remote server for matching with biometric information stored in a database.

In one embodiment, the second case 20 may include one or more circuits to perform conversion, signal processing, and/or control functions in order to place the captured biometric information in a form compatible for transmission through the electrical connector 60 and/or through a network when transmitted from the mobile terminal 30.

The specific type of connector 60 used may be determined, for example, based on the type of charging/accessory port of the mobile terminal 30. When the mobile terminal is a smart phone, the connector 60 may be a port connector of the smart phone. For example, when the mobile terminal 30 is an Android phone (e.g., Samsung Galaxy, S7, S9, etc.), the electrical connector 60 may be or conform to a USB-C type connector. When the mobile terminal 30 is an iPhone, the electrical connector 60 may be or conform to a Lightning-type connector. The cable 98 may include additional connectors on the opposing end, in order to removably connect to corresponding ones of the biometric sensor(s) 22/92. In this case, the cable 98 may split, for example, in a Y-type configuration to connect to the biometric sensors 22/92, respectively. Power for biometric sensors 22/92 may be provided, for example, by connecting a power splitter circuit to the power lines 95, and then routing power to the respective biometric sensors 22 and 92.

While a cable 9.8 is used to transfer signals between the mobile terminal 30 and the biometric sensor(s) 22/92 in this embodiment, cable 98 may be replaced with conductive lines embodied in other forms. For example, instead of a round cable, a flexible flat-ribbon cable with conductive lines may be used to connect the mobile terminal 30 and the biometric sensor(s) 22/92. In another embodiment, wires or conductive traces on a printed circuit board may be used with or instead of cable 98. All of the aforementioned may be generally referred to as conductive lines. In one embodiment, the conductive lines may overlap the rotatable coupling 80.

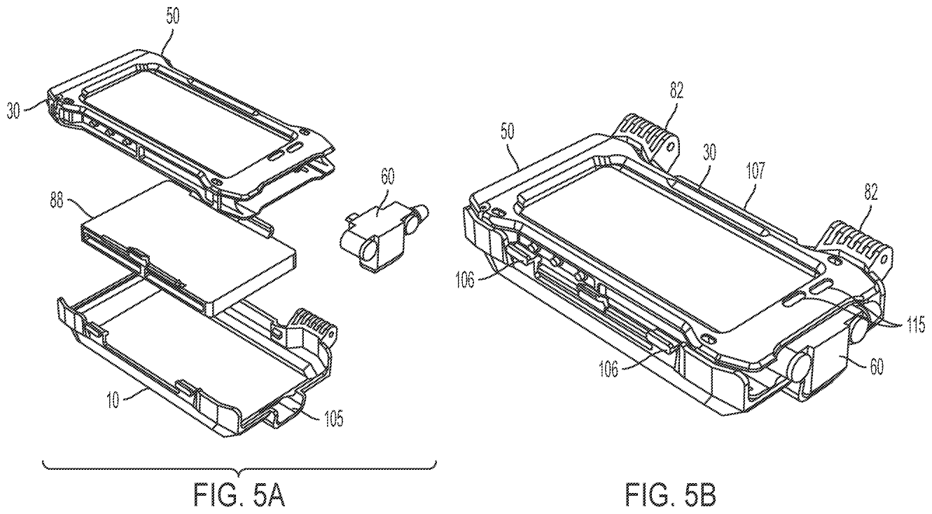

FIG. 5A shows an example of how the battery 88 may be configured within the first case, and FIG. 5B shows an assembled view of the first case 10 including the battery 88. The battery 88 may provide power in addition to power from an internal battery of the mobile terminal 30. In one embodiment, the battery 88 may provide back-up power to the mobile terminal 30 through the connector 60 and/or may provide power to the biometric sensor(s) 22/92, alone or when the internal battery of the mobile terminal 30 used to power the biometric sensor(s) fails below a predetermined level. In alternative embodiments, the second case may be similarly configured to support a battery pack at a position adjacent to the first biometric sensor. In embodiments configured for a battery pack, the battery may be a battery pack including one or more lithium-ion batteries, or may be another type of battery or battery pack.

As shown in FIG. 5A, the thickness of the first case 10 is greater than the thickness of the mobile terminal 30 (or frame 50) by an amount that corresponds to at least the thickness of the battery 88. Thus, the battery may fit between the mobile terminal 30 (and/or frame 50) and an interior surface of the first case 10. The first case may have a recess or side profile 105 which corresponds to the shape of the electrical connector 60. Lip this case, the connector 60 may fit at least partially in the first case 10 (as in FIG. 5B) to prevent the connector from being inadvertently disconnected during use in the field.

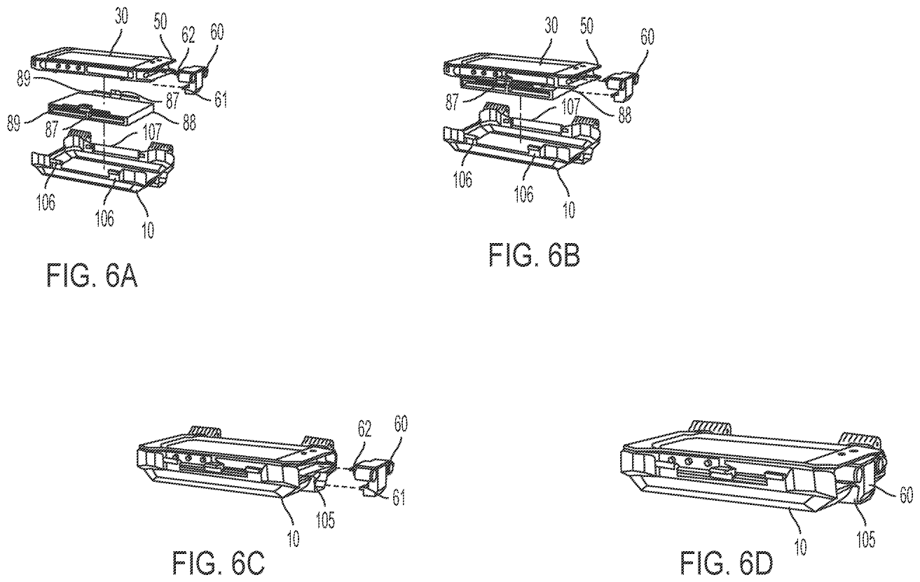

FIGS. 6A-6D show an example of how the first case 10 may be assembled with the connector 60 relative to battery 88 and mobile terminal 30. As shown in FIG. 6A, the connector 60 may include two connector plugs 61 and 62 spaced apart by a distance that will allow them to be removably inserted into corresponding ports of the battery 88 and mobile terminal 30. In this case, the mobile terminal is housed within frame 50. Also, the housing of the battery 88 has side surfaces $9 that project upwardly for mounting purposes.

As shown in FIG. 6B, the battery 88 is attached to the rear surface of the frame 50 when the side surfaces 89 attach to corresponding sides of the frame. The side surfaces 89 may attach to the frame 50 by a friction fit or through deflecting snaps or clips 87 or another type of attachment which, for example, may be on or extend from the side surfaces 89.

As shown in FIG. 6C, the frame 50 including mobile terminal 30 and attached battery 88 are placed in the first case 10. Clips 106 (e.g., see FIG. 5B) extend from one side of the first case 10 and a side bar 107 extends from an opposing side of the first case 10. Assembly is performed by inserting a side of the frame 50 against the side bar 107 and then pressing the frame down until the clips 106 deflect. The clips 106 have elasticity and are biased in a direction toward an interior of the case 10. The frame 50 is secured in the case when the clips 106 push frame 50 against the side bar 170. In order to remove the frame 50 from the first case 10, a user pushes the clips 106 in an outward direction.

When the frame 50 (or mobile terminal 30 in the case where there is no frame) is secured within the case, the electrical connector 60 may be removably installed. In this example embodiment, as previously discussed, connector 60 has two connector plugs 61 and 62 that insert into corresponding ports of battery 88 and mobile terminal 30. In order to install the connector 60, the plugs 61 and 62 are aligned with respective ports in the battery 88 and mobile terminal 30, as indicated by the dotted lines in FIG. 6C. Because battery 88 is at the bottom of the first case 10, connector plug 61 is inserted through a corresponding portion of the recess or side profile 105.

As shown in FIG. 6D, the recess or side profile 105 of the first case matches the shape of the connector 60. Thus, the housing of the plug 60 is partially or completely installed in the first case 10 when assembled. As a result, the matching shape of the first case 10 may protect the connector 60 from being damaged during use, and also provides a compact, efficient design that helps to keep the connector in the plugged-in state relative to the battery 88 and mobile terminal 30. in alternative embodiments having a configuration of the second case suitable for supporting a battery pack at a position adjacent to the first biometric sensor, a plug may be similarly provided for the second case, or the second case may itself include one or more conductive lines for providing power from the battery pack to the first biometric sensor.

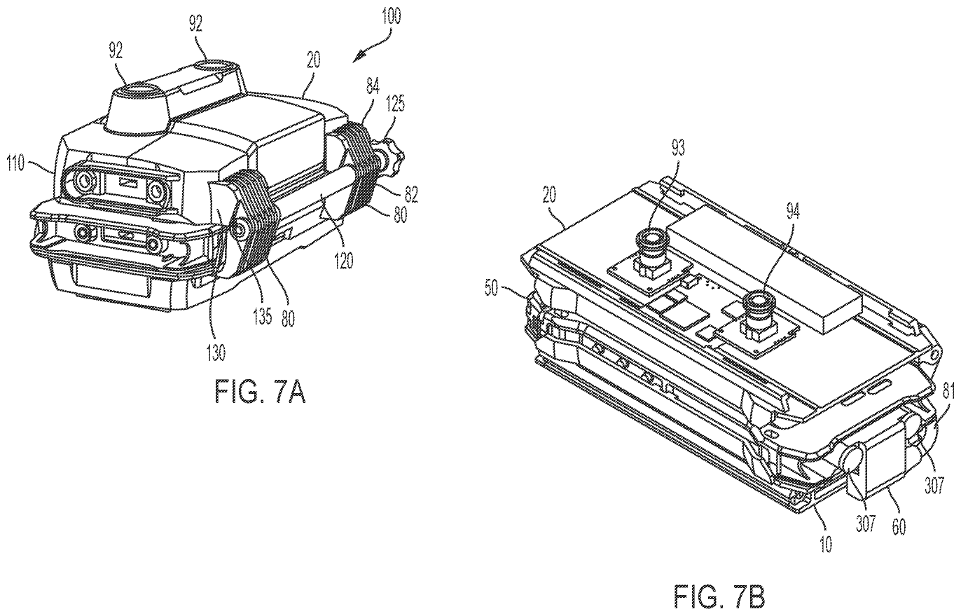

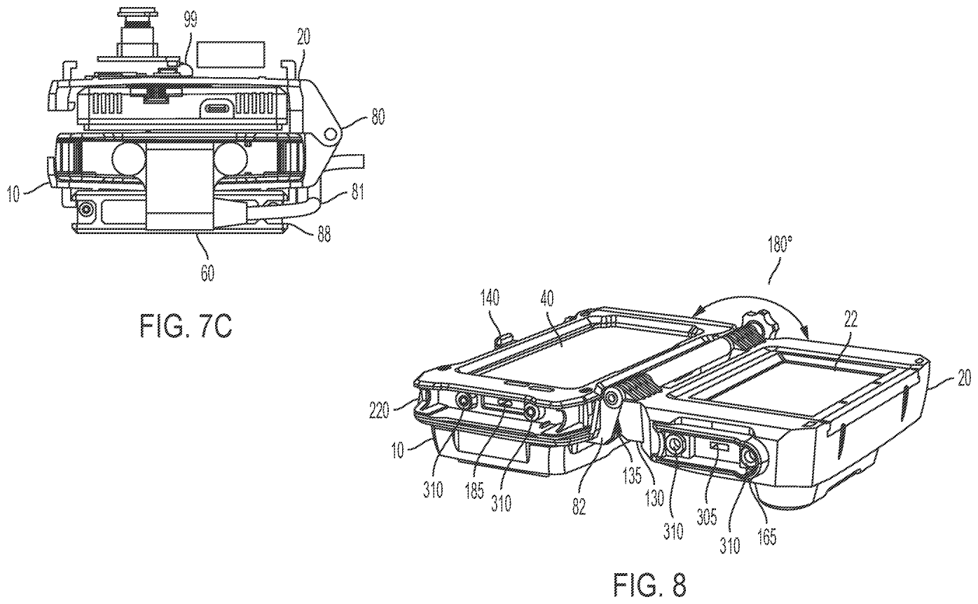

FIG. 7A shows an embodiment of the mobile modular biometric apparatus 100 in a closed state. As shown in FIG. 7A, when closed, the apparatus 100 may have a book-like or clamshell-like shape. The cameras for the dual-iris scanner 92 are shown, in this particular embodiment, to project from a housing or cover 110 on the back of second case 20. A portion of the frame 50 of mobile terminal 30 projects from a side of the apparatus 100 to allow connector 60 and/or charging cables to be plugged into the battery 88 and mobile terminal 30. Buttons 115 of the mobile terminal 30 may be exposed (e.g., see FIG. 5B). In this case, the buttons may be used based on deflectable projections or apertures in corresponding areas of the frame 50.

In the embodiment of FIG. 7A, a pivot rod 120 extends through the rotatable coupling (e.g., hinges) 80 to hold arms 82 and 84 together. The pivot rod 120 may include a rotation controller 125, which may be operated by a user to open and close the apparatus 100. The rotation controller 125 may be or include, for example, a thumb knob with indents to help the grip of the user. Turning the thumb knob 125 in different directions causes the pivot rod 120 to rotate clockwise or counterclockwise, and commensurately opens and closes the first and second cases 10 and 20 relative to one another.

The embodiment of FIG. 7A also includes a stop 130 on or adjacent to the rotatable coupling (one or both hinges) 80. In this example, each stop 130 is adjacent to one of the arms 84 of the rotatable coupling (e.g., a corresponding one of the hinges) 80 extending from the second case 20, Each stop 130 has a surface 135 which abuts one or more opposing arms 82 extending from the first case 10 when the apparatus 100 is in the open position. The stop 130 allows the apparatus to maintain a biometric collection orientation, even when significant pressure is applied to the fingerprint sensor 22 when the apparatus 100 is being held by a user and when the apparatus 100 is lying on a flat surface in the open position.

FIGS. 7B and 7C show an example of the dual-iris scanner 92 when the housing or cover 110 is removed. The cameras 93 and 94 of the dual-iris scanner 92 are mounted on printed circuit boards with integrated circuit chips that capture and process iris images from the cameras. The image data is transmitted through one or more wires 99 and cable 81 to the mobile terminal 30. The one or more wires 99 may be coupled to a USB hub, and the hub may be coupled to a corresponding port in a connector attached to cable 81, for example, as explained below.

FIG. 8 shows an example of how stop 130 abuts an arm 82 when the apparatus is in the open position. As shown, the surface 135 of the stop 130 is oriented at a predetermined angle to prevent the second case 20 from rotating beyond a predetermined point relative to the first case 10 in the open position. The predetermined angle of the surface 135 also ensures that the display screen 40 and sensing surface of the first biometric sensor 22 are arranged at a predetermined orientation relative to one another (e.g., flat or coplanar) for efficient use in the field. As shown in FIG. 8, another optional feature is a close 140 extending from one of the first and second cases 10 and 20 (e.g., first case 10). The close may mate (e.g., snap) to a complementary feature on the second case 20 to keep the cases closed.

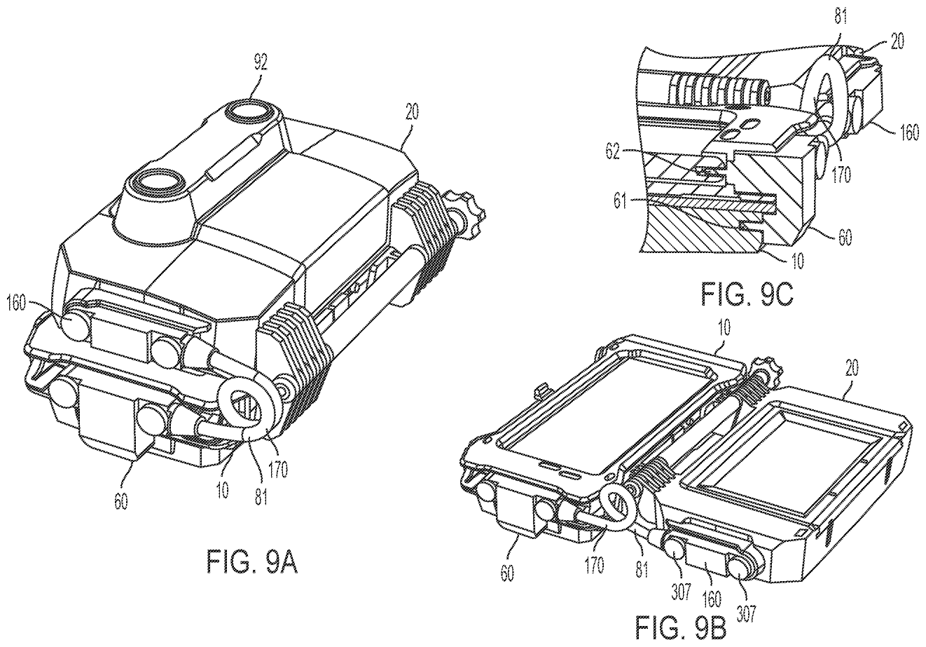

FIGS. 9A-9C show an embodiment where cable 81, for electrically connecting the mobile terminal 30 and biometric sensor(s) 22/92, is disposed along a side of the apparatus 100. The cable 81 may have the same conductive lines as cable 98 previously discussed, or one or more of the conductive lines in cable 1 may be different from the lines in cable 98.

In this embodiment, cable 81 has a first end that includes connector 60 and a second end that includes connector 160. Connector 60 is connected to the battery 88 and mobile terminal 30 in the first case 10, as previously explained. Connector 160 is connected to one or more ports within a connector port housing 165 in the second case 20 (e.g., see FIG. 8) to carry power, control signals, and/or data signals between the mobile terminal 30 and battery 88 and the biometric sensor(s). An example of the one or more ports is shown by reference numeral 305 in FIG. 8.

The length of the cable 81 is sufficient to allow the first and second cases to move between a closed position (FIG. 9A) and an open position (FIGS. 9B and 9C). The cable 81 may have one or more loops 170 for this purpose. FIG. 9C shows, in cross-section, an example of how plugs 61 and 62 are respectively connected to ports in battery 88 and mobile terminal 30. Each connector 60 and 160 may be equipped with one or more screws 307 for insertion into one or more corresponding nuts 310 in order to secure the connectors to respective ones of the cases 10 and 20 (e.g., see FIGS. 7B, 8, and 9B).

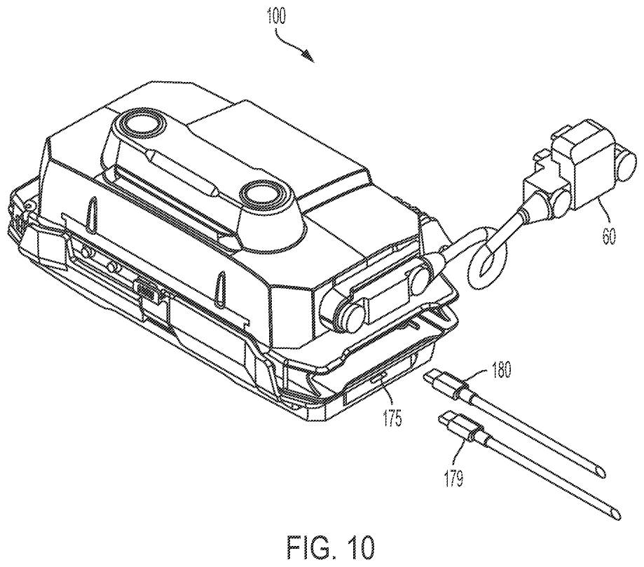

FIG. 10 shows an example of how the mobile modular biometric apparatus 100 may be charged. This involves unplugging the connector 60 to expose the charging ports of the mobile terminal 30 and the battery 88 in the first case 10. An example of the charging port 175 for the battery 88 i s shown in FIG. 10. An example of the charging port 185 for the mobile terminal 30 is shown in FIG. 8. In other embodiments, the second case may comprise a charging port for charging at least the first biometric sensor and/or a battery pack housed in the second case, Once the connector 60 is unplugged, charging cables 179 and 180 may be connected to respective ones of the charging ports 175 and 185.

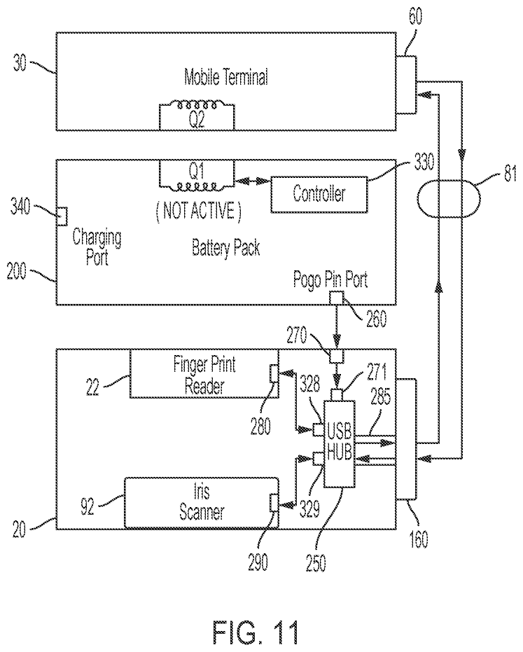

FIG. 11 shows how power, control, and/or data signals may be transmitted in the mobile modular biometric apparatus 100 in accordance with one embodiment.

As shown in FIG. 11, the battery pack 200 may include a Pogo pin port 260 to supply power to one or more of the biometric sensors. In this embodiment, both the fingerprint reader 22 and the iris scanner 92 are included. Power from the battery pack 200 is sent through a Pogo pin port 260 for input into a port 271 of a USB hub 250 through a port 270 of the second case 20. This power may then be supplied to one or both of the biometric sensors 22 and 92. In one scenario, power may be supplied to one or both of the biometric sensors through corresponding signal lines in cable 81 and hub 250. In this case, power through cable 81 may be provided from the mobile terminal 30 and/or battery 88 in the first case 10. In one embodiment, power from the battery pack 200 may be replaced with power from the battery 88, as shown in FIG. 11. In one embodiment, power from any one of the mobile terminal 30, battery 88, and battery pack 200 may be used as primary power for the biometric sensors and the remaining ones of the mobile terminal 39, battery 88, and battery pack 200 may be used as backup power.

The biometric sensors 22 and 92 may include ports (e.g., USB-C ports) 280 and 290, respectively, that are coupled to the USB hub 250. The hub 250 may be coupled to the cable 81 through one or more (e.g., USB-C) ports. A one-port configuration is shown in FIG. 8, where port 305 receives the plug 285 (e.g., see FIG. 11) of connector 160 for carrying signals between the mobile terminal 30 and the biometric sensors through the hub 250. The hub 250 may include ports 328 and 329 for communicating signals with the biometric sensors 22 and 92. The hub 250 and ports may be different from a USB-C standard in another embodiment. Also, one or more signal splitters and routing signal lines or circuits may be used with or in place of the hub 250 to communicate signals between the cable 81 and the biometric sensors 22 and 92.

In another embodiment, the second case 20 may include two or more ports for receiving respective plugs of connector 160. In this case, each plug-and-port combination carries signals between mobile terminal 30 and a respective one of the biometric sensors 22 and 92 through cable 81. In this case, the hub 250 may be connected between the ports of connector 160 and the biometric sensors or the hub 250 may be omitted in favor of corresponding signal lines connected between the ports and respective ones of the biometric sensors. In one embodiment, connector 160 may include complementary plugs that mate with respective connector ports, with each connector port/plug pair carrying power, control, and/or biometric data signals between mobile terminal 30 and the biometric sensors 22 and 92.

The signals transmitted between the cable 81 and the biometric sensors 22 and 92 may be controlled in various ways. In one embodiment, the mobile terminal 30 may be equipped with control software that sends an enable signal to the biometric sensor 22 or 92 to be used at any given time. For example, if an iris scan is to be taken of a subject, a user may open a biometric application program on mobile terminal 30 and then select an option for enabling biometric sensor 92. When this selection is made, mobile terminal 30 sends an enable signal to biometric sensor 92 through cable 81 and hub 250. In one case, the enable signal may be automatically sent when an Iris Scan icon is selected on a menu screen of the mobile terminal 30. Additional selections can then be made to obtain, process, and/or transmit the scan data. Similarly, when a fingerprint menu option is selected, an enable signal may be automatically sent to biometric sensor 22 through cable 81 and hub 250 for capturing one or more fingerprint images of a subject of interest.

In this embodiment, each of the biometric sensors 22 and 92 may be in a default state until an enable signal is received. The default state may be a reduced-power state or a power-off state in order to save battery charge. A disable signal may be automatically sent from mobile terminal 30 to a biometric sensor in use when, for example, the associated biometric data has been received by the mobile terminal 30 and confirmed by a user, e.g., through a complete or other displayed menu option. In one embodiment, a user may selectively push an on/off button on each of the biometric sensors 22 and 92. In this case, the sensor may operate in a mode to communicate with the mobile terminal 30 through the cable 81 in an on-power state and communication is terminated in an off-power state.

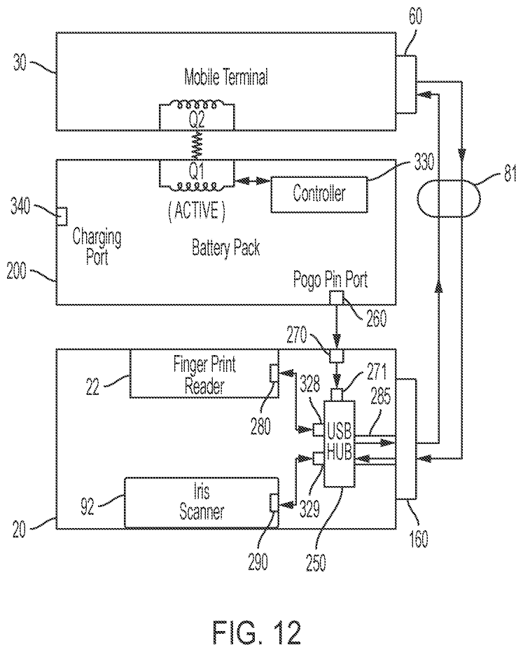

FIG. 12 shows an example where the battery pack 200 (or battery 88 replacing battery pack 200, or both) is a type capable of charging a mobile terminal 30 using an inductive coupling method. In this case, the battery pack (or battery 88) may include a coil Q1 and an internal controller 330 for controlling inductive coupling and charging operations. When a charging cable is connected to a charging port 340 of the battery pack 200, the internal controller 330 controls charging of the battery pack 200. The coil Q1 is not active at this time. When the charging cable is removed from the charging port 340 and a detector detects that another inductive coil Q2 is within a predetermined distance sufficient to transfer power, the internal controller 330 controls an inductive coupling operation to provide non-contact power while the coil Q1 is activated, When the battery pack 200 is not charging and coil Q2 is not in range, the coil Q1 is not active.

The inductive coil Q2 may be included, for example, in the mobile terminal 30. When coil Q2 comes within range, coil Q1 transfers power to coil Q2 through inductive coupling, in order to power the mobile terminal 30. In one embodiment, coil Q2 may be included in the second case 20 for purposes of providing power to one or more of the biometric sensors. When the battery 88 replaces battery pack 200, the coil Q1 may be in a battery pack of battery 88.

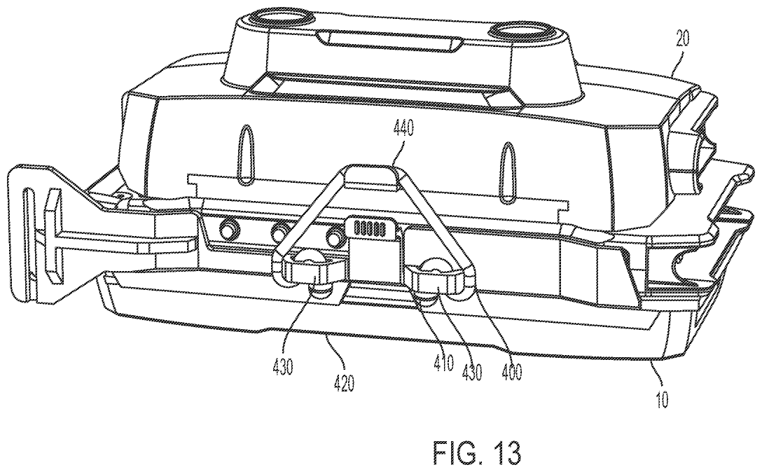

FIG. 13 shows an embodiment of the mobile nodular biometric apparatus which includes a retention strap 400 for securing the first and second cases 10 and 20 in a closed position. The retention strap 400 may be made of rigid material or elastic material (e.g., rubber, bungee, etc.) with sufficient strength to keep the cases in the closed position under forces encountered during travel. The retention strap includes a first end coupled to a first terminal fitting 410 and a second end coupled to a second terminal fitting 420. The terminal fittings may be bails, knots, barrels, ties, or any other terminal feature that will hold the retention strap in place when in use. The retention strap 400 is inserted through one or more holes in projection tabs 430 on the first case 10 and has a length sufficient to wrap around a cantilever 440 on the second case 20. The cases are free to move into an open position when the retention strap 400 is taken off the cantilever 440 by a user. The retention strap 400 may attach the mobile modular biometric apparatus to an arm, forearm, or other body part of a user.

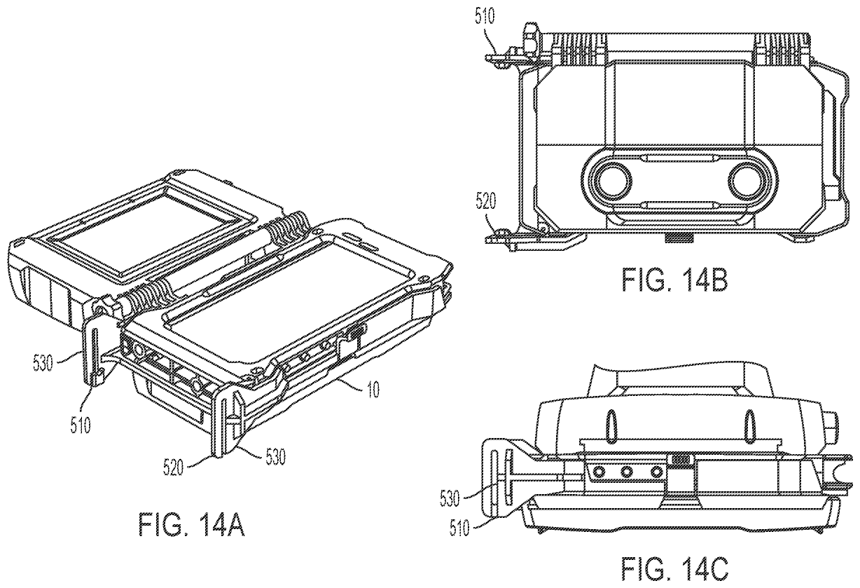

FIG. 14A shows an embodiment of a mobile modular biometric apparatus which is designed to include a hand strap. As shown in FIG. 14A, the first case 10 includes a first attachment surface 510 and a second attachment surface 520 for coupling to respective ends of a retention strap. The first and second attachment surfaces may be any of a variety of attachment types. In the example shown, each of the first and second attachment surfaces 510 and 520 includes a slot 530 for receiving ends of a strap. The ends of the strap may attach like a belt or shoulder strap or another form of removable or replaceable attachment. FIGS. 14B and 14C show side and top views of the mobile modular biometric apparatus including the first and second attachment surfaces 510 and 520.

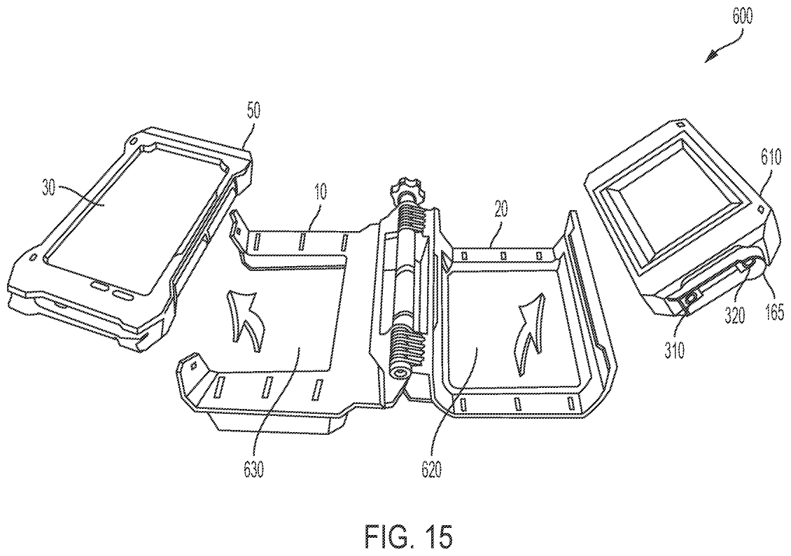

FIG. 15 shows an embodiment of a mobile modular biometric apparatus 600 having a modular design. In one or more embodiments previously discussed, the frame 50 including the mobile terminal 30 (or the mobile terminal 30 when there is no frame) is removable from the first case 10. In this embodiment, the first biometric (e.g., four-slap fingerprint) sensor 22 is in a module housing 610 that is removable from the second case 20. A back surface of the module housing 610 may include a mounting or holder for the second biometric (e.g., dual-iris scanner) sensor 92.

In order to accommodate the module housing 610, the second frame 20 is formed to have a central aperture 620 through which the second biometric sensor 92 may be exposed or extend to collect biometric data. The module housing 610 may include the connector port housing 165 with connector ports, as previously discussed. The first case 10 is shown to include an aperture 630 under the frame 30 including the mobile terminal 30. (The battery 88 is omitted in this drawing for convenience purposes). In another embodiment, the aperture 630 may be omitted, e.g., the first case may have a solid surface under the frame 60 and battery 88.

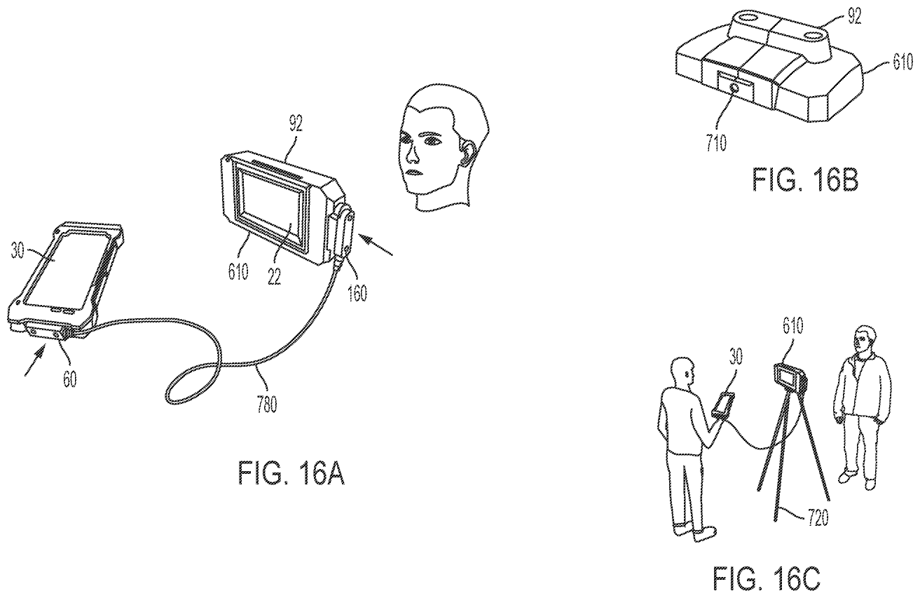

FIGS. 16A-16C show examples of how the modular design of the mobile modular biometric apparatus of FIG. 15 may be used in a decoupled state, e.g., in a state removed from the first and second cases 10 and 20. In FIG. 16A, a longer length cable 780 with connectors 60 and 160 may electrically connect the mobile terminal 30 and the biometric sensors 22 and 92 in the module housing 610. Cable 780 may have the same or different conductive lines as cable 98. Biometric data of a person is captured by cameras of the dual-iris scanner 92 located on the rear surface of the module housing 610. The module housing may be flipped over to allow the four-slap fingerprint sensor 22 to capture the fingerprints of the subject. As shown in FIGS. 16B and 16C, the module housing 610 may be equipped with a mounting hole or nut 710 for attachment to a tripod 720 for purposes of capture biometric data from the iris scanner 92.

An example of the operation of the various embodiments of the mobile modular biometric apparatus will now be discussed. Initially, a user selects a biometric application icon on the display screen 40 of the mobile terminal 30. Selection of this icon initiates display of a main screen of the biometric application. The main screen includes a number of selectable menu options for obtaining biometric information from a subject. The biometric information that may be obtained may be one or more of the types of biometric information previously described.

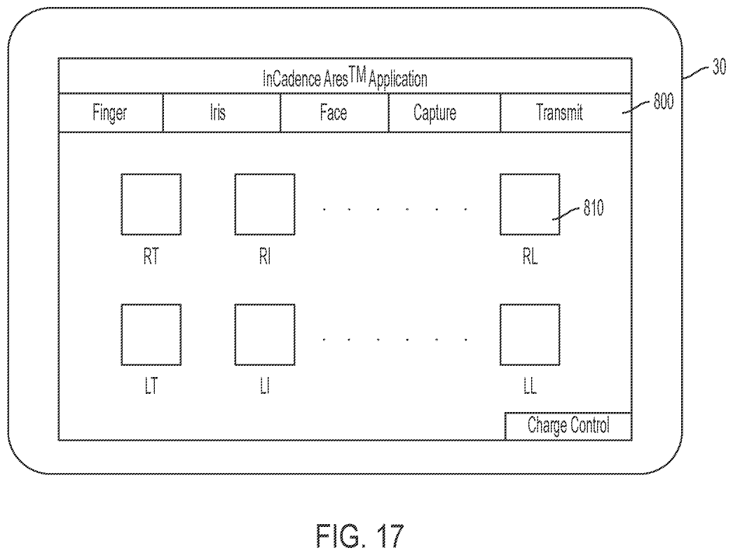

FIG. 17 shows an example of a menu bar 800 indicating selectable options for obtaining fingerprints, an iris scan, and facial recognition information. When a user selection for fingerprints is received, a screen is displayed showing, for example, an empty template corresponding to the biometric information to be obtained. In the case of FIG. 17, the screen shows a number of boxes 810 for respective fingerprints of a subject. The boxes may be presented in a predetermined sequence.

When the empty template is displayed, the user may select the option “capture” on the menu bar. When this option is selected, biometric application program running on the mobile terminal may send power and control signals through the cable 81 to place biometric sensor 22 (in this case, a fingerprint reader) in capture mode, The user may then begin reading the fingerprints, in sequence, of the subject to be identified. The captured biometric information (fingerprint scans) are then digitized and sent, through the data lines of the cable 81, to the mobile terminal 30. The biometric application program then displays the fingerprints. A similar process may be carried out for capture of other types of biometric information, e.g., a dual-iris scan from sensor 92. When multiple biometric sensors are included in or on case 20, selection of the type of biometric data to be captured on menu bar 800 may cause the corresponding sensor to be powered and initiated.

If the user determines the fingerprints to be acceptable, the “transmit” option on the menu bar 800 may be selected. When this option is selected, the fingerprints are transmitted to an external database through a wireless network for comparison to fingerprints information in that database. The results of the comparison are then communicated back to the mobile terminal 30, indicating whether a match was found and the identity of the subject if there was a match. When multiple biometric sensors are included in the second case 20, this operation may be performed sequentially for each type of biometric.

The use of such a biometric application running on a mobile terminal allows for real-time in-the-field identifications to be made. Also, the control software of the application may be written so that updating the biometric application on the mobile terminal 30 will automatically result in updating the control software of the biometric sensor(s). This alleviates the need to update the software of the biometric(s) separately.

In one embodiment, another screen with selectable icons may be displayed on the mobile terminal 30 to control charging operations for the battery pack 88 or 200 and/or to perform an inductive coupling operation using coils Q1 and Q2, as previously described. Additionally, control software may be stored on the mobile terminal 30 to automatically shut off power to the biometric sensors 22 and 92 and the mobile terminal 30 itself when the first and second cases 10 and 20 are placed in a closed position. This may be accomplished, for example, by a s itch or light sensor on an upper surface of one of the cases or on the mobile terminal 30. When the first and second cases are placed in a closed position, the switch is activated or the light sensor detects a certain level of light which triggers a shut off of power to the biometric sensors and/or the mobile terminal 30, or which places the sensors and/or terminal 30 in a reduced power mode. This may save significant battery power and prolong the useful life of the mobile modular biometric apparatus in the field.

The methods, processes, and/or operations in connection with the biometrics application program, operating system software, and other programming features of the embodiments described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods described herein.

The controllers, processors, and other signal processing features of the embodiments described herein may be implemented in non-transitory logic which, for example, may include hardware, software, or both. When implemented at least partially in hardware, the controllers, processors, and other signal processing features may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the controllers, processors, and other signal-processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments or operations of the apparatus embodiments described herein.

In accordance with one or more of the aforementioned embodiments, the folded orientation of the mobile modular biometric apparatus protects a sensing surface at least one of the biometric devices on the second case in the closed position. Also, biometric captures and enrollments may be accomplished while being held by a user and also when the apparatus is placed on a flat surface in the open position. Also, in some embodiments, the battery pack 88 or 200 may be hot-swappable during operation. The battery packs may be lithium-ion battery packs or other types capable of providing power from a predetermined period of time, e.g., 6 hours or more. The apparatus 100 may maintain continuous operation even when an external battery source is used, e.g., battery pack 200. The biometric sensors, battery packs, and/or mobile terminal may operate at a variety of voltage levels, e.g., 110 VAC and 220 VAC.

Any reference in this specification to an “embodiment” means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. The features of any one embodiment may be combined with features of one or more other embodiments described herein to form additional embodiments.

Although the present invention has been described herein with reference to a number of illustrative embodiments, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

We claim:

1. A mobile modular biometric apparatus, comprising:
a first case configured to support a mobile terminal;
a second case configured to support a first biometric sensor;
a coupler configured to rotatably couple the first case to the second case; and
a plurality of conductive lines configured to carry signals between the mobile terminal and the first biometric sensor, the signals comprising biometric information from the first biometric sensor, wherein the coupler is configured to control the first case and the second case to rotate between an open position and a closed position, the first case overlapping the second case in the closed position and having a different orientation relative to the second case in the open position.

2. The apparatus of claim 1, wherein the different orientation is a side-by-side orientation.

3. The apparatus of claim 1, wherein the first case is configured to support a display screen of the mobile terminal and the second case is configured to support a sensing surface of the first biometric sensor in a same direction in the open position.

4. The apparatus of claim 1, wherein the first case is configured to support a display screen of the mobile terminal and the second case is configured to support a sensing surface of the first biometric sensor in a different direction in the open position.

5. The apparatus of claim 1, wherein the coupler comprises at least one hinge configured to rotatably couple the first case to the second case.

6. The apparatus of claim 1, further comprising:
a stop configured to set the first case at a predetermined angle relative to the second case in the open position.

7. The apparatus of claim 1, further comprising:
a rotation controller configured to move the first case and the second case between the open position and the closed position.

8. The apparatus of claim 1, Wherein:
the first case comprises a removable coupling to the mobile terminal; and
the second case comprises a removable coupling to the first biometric sensor.

9. The apparatus of claim 1, wherein the second case is configured to support a second biometric sensor, the second case comprising opposing sides configured to support the first biometric sensor and the second biometric sensor, respectively.

10. The apparatus of claim 9, wherein one or more of the plurality of conductive lines are configured to carry power to the first biometric sensor and the second biometric sensor.

11. The apparatus of claim. 9, further comprising:
a hub configured to control signal transmission between the plurality of conductive lines and the first biometric sensor and the second biometric sensor.

12. The apparatus of claim 1, wherein the first case is configured to support a battery pack at a position adjacent to the mobile terminal or wherein the second case is configured to support a battery pack at a position adjacent to the first biometric sensor.

13. The apparatus of claim 12, wherein the first case is configured to hold the battery pack at a distance from the mobile terminal sufficient to allow inductive charging to take place between coils in the battery pack and mobile terminal.

14. The apparatus of claim 12, wherein:
the first case comprises a recess corresponding to a profile of a connector of the plurality of conductive lines, and
a surface of the first case is configured to at least partially surround the connector when the connector is located in the recess.

15. The apparatus of claim 14, wherein the recess is configured to expose charging ports of the mobile terminal and battery pack, the surface of the first case configured to at least partially surround a portion of the connector which comprises connector plugs configured to be inserted into respective ones of the charging ports.

16. The apparatus of claim 12, wherein one or more of the plurality of conductive lines are configured to carry power from the battery pack or mobile terminal to the first biometric sensor.

17. The apparatus of claim 1, further comprising:
a retention strap configured to maintain the first case and the second case in the closed position.

18. The apparatus of claim 1, further comprising:
an attachment on the first case or the second case configured to receive a hand strap.

19. The apparatus of claim 1, wherein the mobile terminal is a smart phone, a tablet, and handheld computer, or a personal digital assistant.

20. The apparatus of claim 1, wherein the first biometric sensor is a fingerprint reader, palm reader, palm vein reader, an iris scanner, retina scanner, a microphone for voice recognition, or a camera for recognition of a body part or body feature.
